(19) United States
(12) Patent Application Publication
(10) Pub. No.: US 2013/0339237 A1
(43) Pub. Date: Dec. 19, 2013

(54) METHODS AND SYSTEMS FOR INVESTIGATING FRAUDULENT TRANSACTIONS

(71) Applicants: Daniel Jeremy Rich, San Diego, CA (US); Richard Barry Husa, St. Charles, MO (US)

(72) Inventors: Daniel Jeremy Rich, San Diego, CA (US); Richard Barry Husa, St. Charles, MO (US)

(21) Appl. No.: 13/523,621

(22) Filed: Jun. 14, 2012

(51) Int. Cl. G06Q 40/00

(52) U.S. Cl. 705/44; 705/39

(57) ABSTRACT

Computer systems and methods for managing the investigation of potentially fraudulent payment card transactions are provided. The computer system includes a memory device for storing data and a processor in communication with the memory device. The computer system is programmed to retrieve a case representing at least one transaction initiated with a payment card and designated as potentially fraudulent, provide the case to a contact management system, retrieve cardholder card and contact information for the actual cardholder associated with the payment card used in the at least one transaction, and provide the cardholder card and contact information to the contact management system, wherein the contact management system is configured to initiate an investigation into the case based on the cardholder card and contact information.

### BACKGROUND OF THE INVENTION

The field of the invention relates generally to methods and systems for investigating fraudulent transactions and, more particularly, to computer-implemented methods and systems for managing payment card transactions identified as potentially fraudulent, including managing the investigation into each of the identified transactions.

Issuers of payment cards face lost revenue and significant costs for fraudulent transactions. At least some known fraud detection systems are used by payment card issuers for detecting at least some fraudulent transactions initiated over a payment card network. These known fraud detection systems use different processes and/or models to detect fraud. Once a transaction is designated as a fraudulent transaction, in at least some known cases, a human analyst investigates the case to determine whether further steps should be taken.

What is needed is an automated system that, upon a transaction being marked as potentially fraudulent, can automatically implement and manage an investigation, communicate with the cardholder, determine if the transaction is authorized, and take steps to stop subsequent transactions if the cardholder indicates fraudulent activity.

### BRIEF DESCRIPTION OF THE INVENTION

In one embodiment, a computer system for managing an investigation of potentially fraudulent payment card transactions is provided. The computer system includes a memory device for storing data and a processor in communication with the memory device. The computer system is programmed to retrieve a case representing at least one transaction initiated with a payment card and designated as potentially fraudulent, provide the case to a contact management system, retrieve cardholder card and contact information for the actual cardholder associated with the payment card used in the at least one transaction, and provide the cardholder card and contact information to the contact management system, wherein the contact management system is configured to initiate an investigation into the case based on the cardholder card and contact information.

In another embodiment, a computer-implemented method of managing an investigation of potentially fraudulent payment card transactions using a virtual analyst computing device is provided. The virtual analyst computing device includes a memory device and a processor. The method includes using the virtual analyst computing device to retrieve case data representing at least one transaction initiated with a payment card and designated as potentially fraudulent, transmitting the case data to a contact management computing system, using the virtual analyst computing device to retrieve cardholder card and contact information for the actual cardholder associated with the payment card used in the at least one transaction, and providing the cardholder card and contact information to the contact management computing system, wherein the contact management computing system is configured to initiate an investigation into the case based on the cardholder card and contact information.

In yet another embodiment, one or more non-transitory computer-readable storage media having computer-executable instructions embodied thereon for managing an investigation of potentially fraudulent payment card transactions by a computing device is provided. The computing device includes a memory device and a processor. When executed by the processor, the computer executable instructions cause the processor to retrieve a case representing at least one transaction initiated with a payment card and designated as potentially fraudulent, provide the case to a contact management system, retrieve cardholder card and contact information for the actual cardholder associated with the payment card used in the at least one transaction, and provide the cardholder card and contact information to the contact management system, wherein the contact management system is configured to initiate an investigation into the case based on the cardholder card and contact information.

### BRIEF DESCRIPTION OF THE DRAWINGS

FIG. 1 is a schematic diagram illustrating an exemplary multi-party payment card industry system for enabling ordinary payment transactions in which merchants and card issuers do not necessarily have a one-to-one relationship.

FIG. 2 is a simplified block diagram of an exemplary payment processing system, including a fraud management platform in accordance with one embodiment of the present invention.

FIG. 3 is an expanded block diagram of an exemplary embodiment of a server architecture of a payment processing system including the fraud management platform shown in FIG. 2 in accordance with one embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 illustrates an exemplary configuration of the fraud management platform shown in FIGS. 2 and 3 in accordance with an exemplary embodiment of the present invention.

FIG. 7 is a data flow diagram showing the communications of the fraud management platform shown in FIGS. 2, 3, and 6 between the virtual analyst system, the fraud scoring system, the contact management system, the cardholder management system, and the issuer interface in accordance with an exemplary embodiment of the present invention.

### DETAILED DESCRIPTION OF THE INVENTION

Embodiments of the present invention herein relate generally to a fraud management platform for investigating potentially fraudulent payment card transactions processed over a payment card network. The fraud management platform includes a virtual analyst system, a fraud scoring system, a contact management system, a cardholder management system, and, optionally, an issuer interface. In one embodiment, the fraud management platform is associated with the payment card network, i.e., an interchange network. In another embodiment, the fraud management platform is separate from the payment card network and is associated with a third-party processor. In this other embodiment, the fraud management platform is in communication with the payment card network.

The fraud management platform includes the virtual analyst system, which serves as an automatic interface, linking multiple, separate systems used for detecting, scoring, processing, verifying, and storing information accumulated during review of a payment card transaction with a cardholder. In the example embodiment, the virtual analyst system interfaces between the fraud scoring system, the contact management system, the cardholder management system, and, optionally, the issuer interface. In the example embodiment, the fraud scoring system typically determines a likelihood of a transaction involving a payment card being fraudulent. The contact management system is configured to contact the registered cardholder for verification purposes of cases labeled as possibly fraudulent. The cardholder management system is configured to store cardholder payment card information and cardholder contact information. The issuer interface is configured to enable the virtual analyst system to interface with an issuer computing device for accessing additional cardholder card information and cardholder contact information that is stored with the issuer of the payment card.

In operation, when a cardholder initiates a transaction by swiping a payment card or using a payment card over the payment card network, an authorization request message for the transaction is transmitted over the payment card network to an issuer processor for authorization of the transaction. The fraud scoring system receives the authorization request message, including the transaction information, on behalf of the fraud management platform. The fraud scoring system may use a variety of fraud scoring algorithms to generate a fraud score for the transaction, indicating the likelihood that the transaction is fraudulent. If the fraud score generated by the fraud scoring system meets a threshold level (i.e., that the transaction is potentially fraudulent), the fraud scoring system creates a “case” for this transaction for further review by either a human analyst or the fraud management platform. The fraud scoring system associates the case with one or more queues in a database included in the fraud scoring system.

For analyzing potentially fraudulent cases, the contact management system contacts the virtual analyst system at predetermined time intervals and requests a list of cases to be analyzed. Upon receiving the request from the contact management system, the virtual analyst system requests the case and transaction data from the fraud scoring system. The fraud scoring system provides at least one of the cases designated as potentially fraudulent and associated within the one ore more queues. The virtual analyst system contacts the cardholder management system and requests the cardholder card information and the cardholder contact information for the case provided to it by the fraud scoring system for further investigation. In another embodiment, an issuer may store cardholder contact information within a database associated with the issuer. In this other embodiment, the virtual analyst system may request the additional cardholder contact information and cardholder preferences through the issuer interface. The contact management system communicates update data, which represents updated cases status data, to the virtual analyst system when it begins to process the case and in turn, the virtual analyst system contacts the fraud scoring system to update the case status with the update data in the fraud scoring system database.

Upon receiving the case information and the cardholder's card and contact information, the contact management system uses its rule-based engine to determine when and how to contact the cardholder to verify the transaction. The cardholder may specify preferred forms of communication for contacting the cardholder in the event of potentially fraudulent activity. The forms of communication include a phone call, an email, and/or a text message. Depending on the form of communication chosen by the cardholder, there may be a set timeframe, or contact window, for the contact management system to initiate contact with the cardholder. If the contact window is open, the contact management system attempts to contact the cardholder. If the window is closed, the contact management system schedules a contact attempt during an open contact window time. At the scheduled time, the contact management system requests case update data from the virtual analyst system to confirm the case has not been closed or handled by another analyst. As part of the case update, the virtual analyst system contacts the fraud scoring system to retrieve any case update data, which is then provided to the contact management system via the virtual analyst system.

After each attempt at contacting the cardholder, the contact management system updates the virtual analyst system. In turn, the virtual analyst system may perform a number of operations depending on the information received from the contact management system. The virtual analyst system may update the fraud scoring system database with case update data or investigation data that includes the cardholder's response for updating the fraud scoring system's scoring algorithms. The virtual analyst system may also forward the case to another user or group within the fraud management platform. The virtual analyst system may update the cardholder management system with card status data representing the status of the cardholder's payment card, or may update cardholder information data associated with the cardholder's contact information and contact preferences. If the card issuer operates its own issuer customer information database, the virtual analyst system may communicate the updated card status data and/or the cardholder information data via the issuer interface.

The methods and systems described herein may be implemented using computer programming or engineering techniques including computer software, firmware, hardware or any combination or subset thereof, wherein the technical effect may include at least one of: (i) retrieving a case representing at least one transaction initiated with a payment card and designated as potentially fraudulent; (ii) providing the case to a contact management system; (iii) retrieving cardholder card and contact information for the actual cardholder associated with the payment card used in the at least one transaction; and (iv) providing the cardholder card and contact information to the contact management system, wherein the contact management system is configured to initiate an investigation into the case based on the cardholder card and contact information.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of payment card can be used as a method of payment for performing a transaction. In addition, cardholder account behavior can include but is not limited to purchases, management activities (e.g. balance checking), bill payments, achievement of targets (meeting account balance goals, paying bills on time), and/or product registrations (e.g. mobile application downloads).

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in a variety of applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

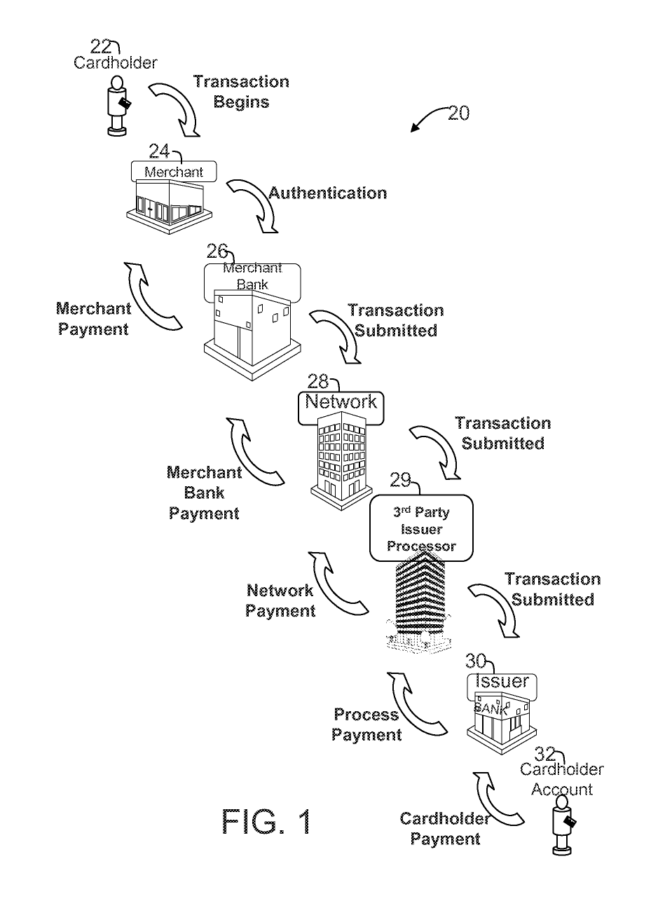

FIG. 1 is a schematic diagram illustrating an exemplary multi-party payment card industry system 20 for enabling ordinary payment-by-card transactions in which merchants 24 and card issuers 30 do not need to have a one-to-one special relationship. Embodiments described herein may relate to a payment card system, such as a credit card payment system using the MasterCard® interchange network (MasterCard is a registered trademark of MasterCard International Incorporated located in Purchase, New York). The MasterCard interchange network is a set of proprietary communications standards promulgated by MasterCard International Incorporated for the exchange of financial transaction data and the settlement of funds between financial institutions that are members of MasterCard International Incorporated. In a typical payment card system, a financial institution called the “issuer” issues a payment card, such as a credit card, to a consumer or cardholder 22, who uses the payment card to tender payment for a purchase from a merchant 24. To accept payment with the payment card, merchant 24 must normally establish an account with a financial institution that is part of the financial payment system. This financial institution is usually called the “merchant bank,” the “acquiring bank,” or the “acquirer.” When cardholder 22 tenders payment for a purchase with a payment card, merchant 24 sends an authorization request to a merchant bank 26 for the amount of the purchase. The request may be performed over the telephone, but is usually performed through the use of a point-of-sale device, which reads cardholder's 22 account information from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale device will be configured to communicate with the third party. Such a third party is usually called a “merchant processor,” an “acquiring processor,” or a “third party processor.”

Using an interchange network 28, computers of merchant bank 26 will communicate transaction information with computers of an issuer processor 29 associated with an issuer 30. Issuer processor 29 may be a third party processor authorized to perform transaction-related services on behalf of issuer 30, including payment card production services, payment card processing services, fraud detection services, data delivery services, ATM driving services, transaction research, and cardholder support services. Issuer processor 29 may also provide interbank switch processing, including authorization, clearing and settlement, and value-added services. This enables issuer 30 to use one card processor for all different payment card brands. In an alternative embodiment, issuer processor 29 may be associated with interchange network 28 and may provide similar services.

Issuer 30 receives the transaction information from issuer processor 29, and then determines whether cardholder's 22 account 32 is in good standing and whether the purchase is covered by cardholder's 22 available credit limit. Based on these determinations, the request for authorization will be declined or accepted. If the request is accepted, an authorization code is issued to merchant 24.

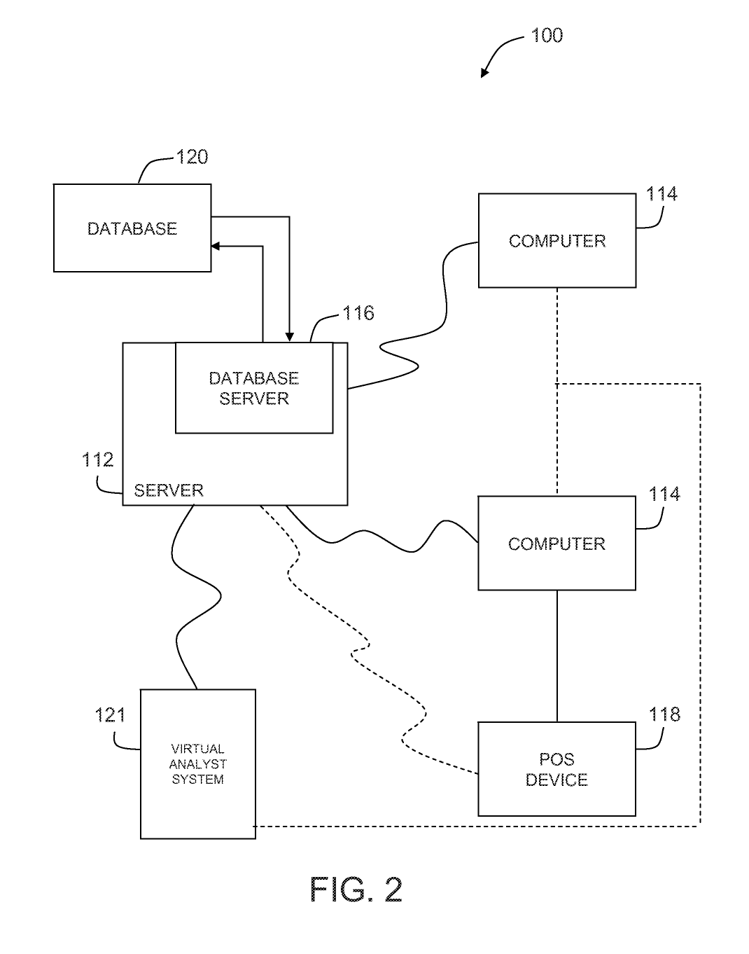

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale device. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer 30 stores the payment card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, issuer processor 29, and issuer 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, interchange network 28, issuer processor 29, and issuer 30. Settlement refers to the transfer of financial data or funds among merchant's 24 account, merchant bank 26, issuer processor 29, and issuer 30 related to the transaction. Usually, transactions are captured and accumulated into a “batch,” which is settled as a group. More specifically, a transaction is typically settled between issuer 30 and issuer processor 29, and then between issuer processor 29 and interchange network 28, and then between interchange network 28 and merchant bank 26, and then between merchant bank 26 and merchant 24.

FIG. 2 is a simplified block diagram of an exemplary payment processing system 100 including a fraud management platform in accordance with one embodiment of the present invention. In the example embodiment, system 100 is configured to process payment-by-card transactions, determine whether a transaction is potentially fraudulent, open a case for a potentially fraudulent transaction, manage the investigation of open cases, and update open cases with results of reviewed investigations.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes a point-of-sale (POS) device 118, which may be connected to client systems 114, and may be connected to server system 112. POS device 118 is interconnected to the Internet through many interfaces including a network, such as a LAN or a WAN, dial-in-connections, cable modems, wireless modems, and/or special high-speed ISDN lines. POS device 118 can be any device capable of interconnecting to the Internet and includes an input device capable of reading information from a cardholder's payment card.

A database server 116 is connected to a database 120, which contains information on a variety of matters, as described below in greater detail. In one embodiment, database 120 is stored on centralized server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, and/or purchases made. Database 120 may also store cardholder account data including a name, an address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

System 100 may also include a fraud management platform 121, which may be connected to one or more client systems 114, and may be connected to server system 112. Fraud management platform 121 is interconnected to the Internet through many interfaces including a network, such as a LAN or a WAN, dial-in-connections, cable modems, wireless modems, and/or special high-speed ISDN lines. In one embodiment, fraud management platform 121 is located remotely from server system 112 and may be non-centralized. In an alternative embodiment, fraud management platform 121 is located on server system 112 and can be accessed by potential users at one of client systems 114 by logging onto server system 112 through one of client systems 114. Fraud management platform 121 is capable of detecting, scoring, processing, verifying, and storing information accumulated during review of a payment card transaction with a cardholder.

In the exemplary embodiment, one of client systems 114 may be associated with merchant bank 26 (shown in FIG. 1) while another one of client systems 114 may be associated with issuer 30 (shown in FIG. 1). POS device 118 is associated with a participating merchant 24 (shown in FIG. 1) or may be a computer system and/or mobile system used by cardholder 22 (shown in FIG. 1) making an on-line purchase or payment. Fraud management platform 121 is associated with a payment card network, such as interchange network 28 (shown in FIG. 1), or may be associated with issuer processor 29 (shown in FIG. 1) or issuer 30. In the exemplary embodiment, server system 112 is associated with interchange network 28. Server system 112 may be used for processing transaction data. In addition, client systems 114 and/or POS device 118 may include a computer system associated with at least one of an online bank, a bill payment outsourcer, a merchant bank, a merchant processor, an issuer associated with a payment card, an issuer processor, a remote payment system, and/or a biller.

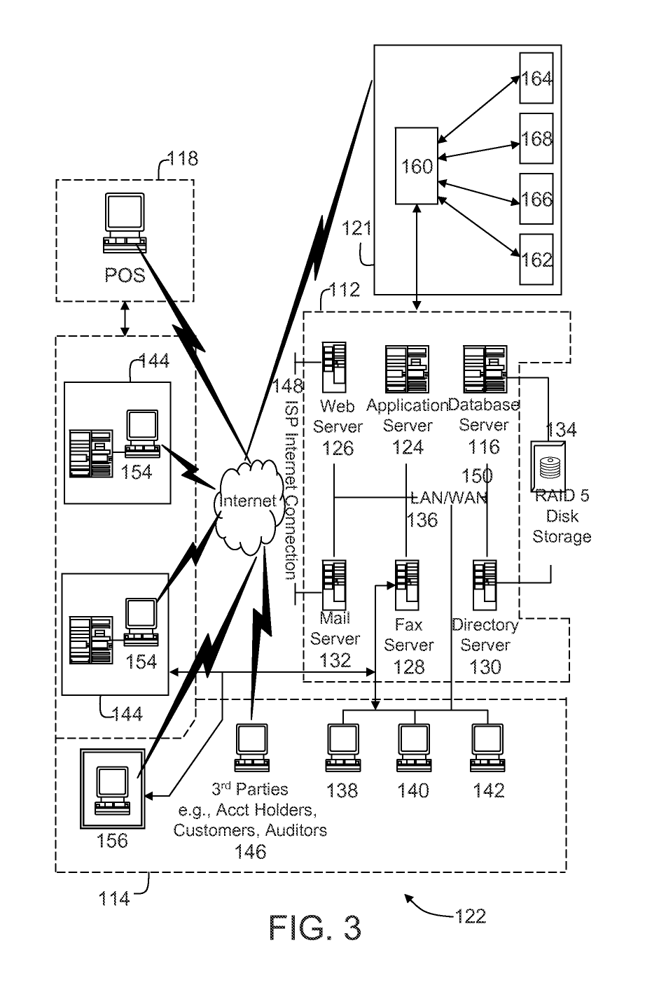

FIG. 3 is an expanded block diagram of an exemplary embodiment of a server architecture of a payment processing system 122 including fraud management platform 121 in accordance with one embodiment of the present invention. Components in system 122, identical to components of system 100 (shown in FIG. 2), are identified in FIG. 3 using the same reference numerals as used in FIG. 2. System 122 includes server system 112, client systems 114, POS device 118, and fraud management platform 121. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a LAN 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through the Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other WAN type communication can be utilized in other embodiments, i.e., the systems and processes are not limited to being practiced using the Internet. In addition, and rather than WAN 150, LAN 136 could be used in place of WAN 150.

In the exemplary embodiment, any authorized individual having a workstation 154 can access system 122. At least one of client systems 114 includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

In the exemplary embodiment, fraud management platform 121 is in communication with server system 112 and/or client systems 114 and other workstations through a network connection. In the exemplary embodiment, fraud management platform 121 includes a virtual analyst system 160 that acts as an interface between a fraud scoring system 162, a contact management system 164, and a cardholder management system 166. In an alternative embodiment, fraud management platform 121 also includes an issuer interface 168 in communication with virtual analyst system 160.

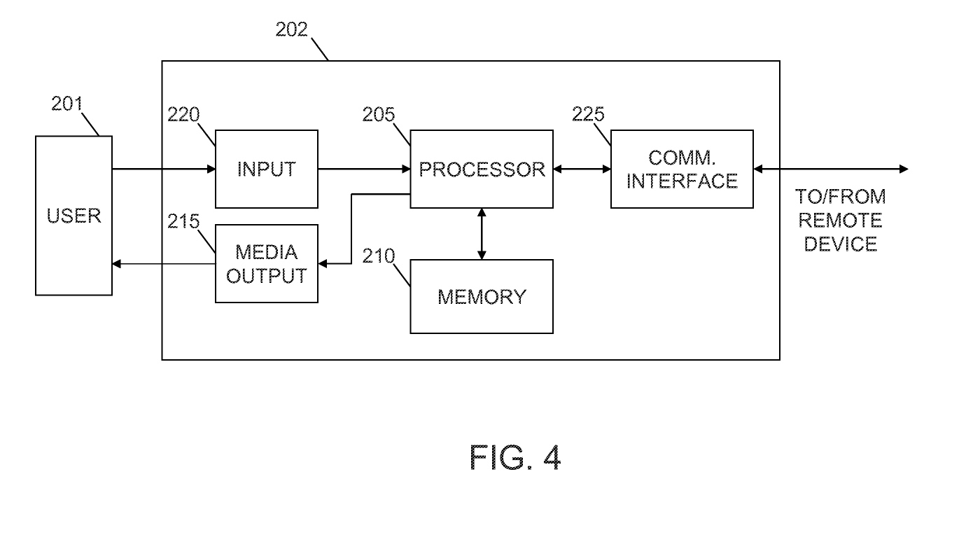

FIG. 4 illustrates an exemplary configuration of a user system 202 operated by a user 201 in accordance with one embodiment of the present invention. User system 202 may include, but is not limited to, fraud management platform 121, client systems 114, 138, 140, and 142, POS device 118, workstation 154, and manager workstation 156 (all shown in FIG. 3). In the exemplary embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, 4G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

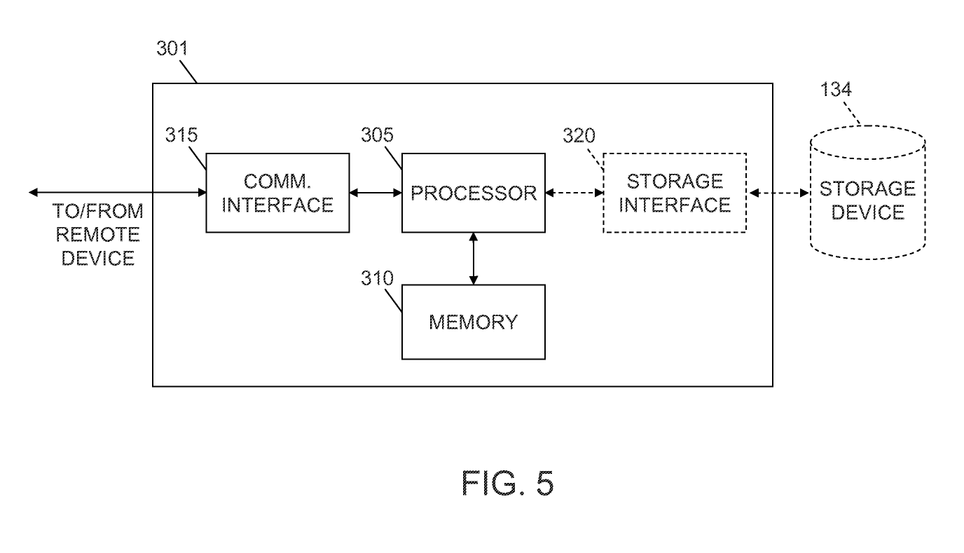

FIG. 5 illustrates an exemplary configuration of a server system 301, such as server system 112 (shown in FIGS. 2 and 3). Server system 301 may include, but is not limited to, database server 116, application server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

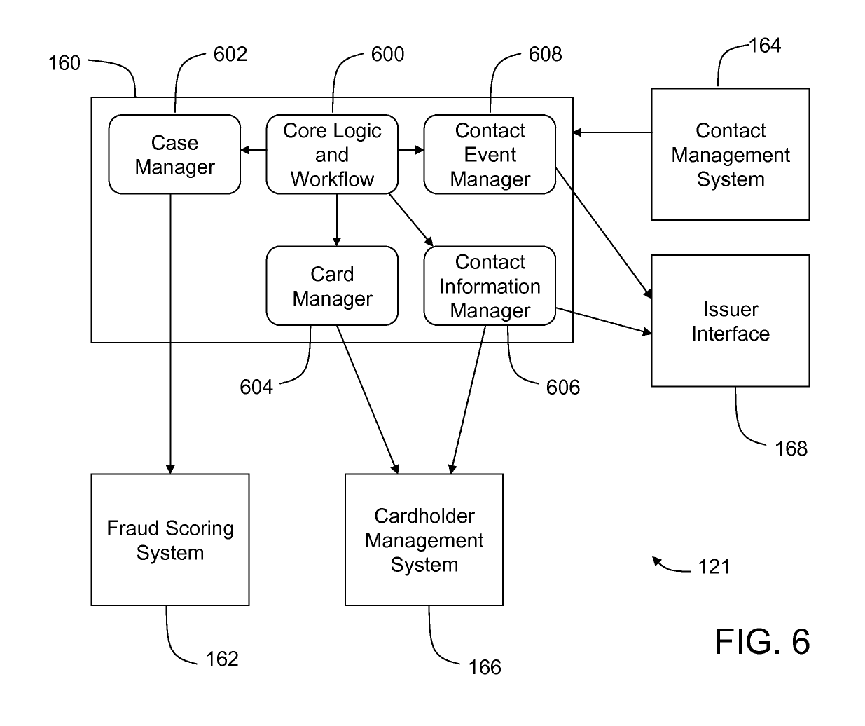

FIG. 6 is block diagram of an exemplary fraud management platform 121 as shown in FIGS. 2 and 3 in accordance with the present invention. In the exemplary embodiment, fraud management platform 121 is associated with a payment card network, such as interchange network 28 (shown in FIG. 1). In an alternative embodiment, fraud management platform 121 is associated with a third-party payment processor, such as issuer processor 29 (shown in FIG. 1).

Fraud management platform 121 includes virtual analyst system 160, fraud scoring system 162, contact management system 164, and cardholder management system 166 (shown in FIG. 3). In an alternative embodiment, fraud management platform 121 also includes issuer interface 168 (shown in FIG. 3). Virtual analyst system 160 serves as an automatic interface, linking multiple, separate systems used for detecting, scoring, processing, verifying, and storing information accumulated during review of a payment card transaction with a cardholder. Virtual analyst system 160 serves as an interface between fraud scoring system 162, contact management system 164, and cardholder management system 166.

Virtual analyst system 160 includes a core logic and workflow 600, which serves as an interface between the other four virtual analyst system 160 components: a case manager 602, a card manager 604, a contact information manager 606, and a contact event manager 608. Case manager 602 communicates with fraud scoring system 162 to obtain case transaction data and request fraud scoring system 162 to update case status, add notes, and move cases. Card manager 604 communicates with cardholder management system 166 to update and/or obtain card status data for specified payment cards. Contact information manager 606 communicates with cardholder management system 166 to update or obtain cardholder segmentation values and/or cardholder contact information. In an alternative embodiment, contact event manager 608 communicates through issuer interface 168 to update or obtain contact information.

Fraud scoring system 162 is configured to validate payment card transactions by providing real-time or near real-time fraud scores that indicate the likelihood that a transaction is fraudulent. In the exemplary embodiment, fraud scoring is offered as part of a payment card network's services when processing transaction data. When an authorization request is received by the payment card network, the network determines whether the merchant bank and/or issuer have subscribed to the fraud scoring service offered by fraud scoring system 162. If so, the transaction data is transmitted to fraud scoring system 162 to calculate a fraud score for the transaction and determine if it is potentially fraudulent.

Fraud scoring system 162 implements a set of rules or criteria that define a transaction by various characteristics associated with the transaction. The criteria may include the amount and the location of a transaction, the type of goods, the type of merchant, and/or the value of the fraud score. When a transaction meets a threshold of the criteria, fraud scoring system 162 creates a case, indicating the transaction is potentially fraudulent and needs further review by an analyst. Based on predetermined criteria, when a transaction is marked as potentially fraudulent, fraud scoring system 162 decides whether to decline the transaction, or approve the transaction and create a case to be analyzed. When fraud scoring system 162 decides to approve the transaction and create a case, fraud scoring system 162 associates the case with at least one queue and stores the case in a database. Each queue is associated with specific criteria and is built to match specific rules, such that each case in a queue shares certain characteristics. Queues are assigned to either a human analyst or to fraud management platform 121 for further analysis. Because a transaction may have multiple characteristics (i.e., amount, location, type of merchant, etc.), a case created for any specific transaction may be associated with multiple queues. When a case is associated with multiple queues, a status is assigned to the case when an analyst first accesses it. Thereafter, the case remains in a queue associated with that specific status until the case is closed or an analyst associates it with a different queue. In the exemplary embodiment, fraud scoring system 162 is FICO™ Falcon™ Fraud Manager (FICO and FALCON are both trademarks of FICO, of Minneapolis, Minn.).

Contact management system 164 is configured to communicate with cardholders to investigate potentially fraudulent transactions. Contact management system 164 contacts virtual analyst system 160 at predetermined time intervals to request a list of cases to be worked. Virtual analyst system 160 communicates with fraud scoring system 162 to provide the list of cases to contact management system 164. Upon receiving the list of cases, contact management system 164 contacts virtual analyst system 160 and requests case information and the cardholder's card and contact information for a specific case from the list. Cardholder contact information may include the cardholder's name, address, phone number, email address, and any other forms of communicating with a cardholder. Cardholder contact information also may also include contact preferences, including a timeframe in which to be contacted, events to occur for contact to be made, and the form of communication. Virtual analyst system 160 requests the case information and cardholder's card and contact information from fraud scoring system 162 and cardholder management system 166, as necessary. After receiving the requested information, contact management system 164 communicates update data to virtual analyst system 160, indicating a working status for the case. In turn, virtual analyst system 160 communicates the update data to fraud scoring system's 162 database.

Contact management system 164 then determines an appropriate time and form of communication to use to contact the cardholder based on preferences specified by the cardholder. For example, the cardholder may specify to be contacted by cell phone, home phone, work phone, text message, and/or email. The cardholder preferences may also include a timeframe, or window, for when to make contact. Contact management system 164 attempts to contact the cardholder if the contact window is open. If the contact window is closed, contact management system 164 sets a scheduled time within the contact window to attempt the next contact. When the scheduled time arrives, contact management system 164 first contacts virtual analyst system 160 to request update data for the case. If the case has been closed, no action is taken. If the case is being processed by another analyst, contact management system 164 sets another scheduled time to check the case status. If the case remains open, contact management system 164 contacts virtual analyst system 160 to request update data for the case and any updated cardholder information data. Contact management system 164 then attempts to contact the cardholder. If no contact is made, contact management system 164 schedules another time within the contact window to attempt contact. If contact is made, contact management system 164 verifies the authenticity of the transaction or transactions in question with the cardholder. Verification may occur by automatic voice recognition using verbal commands on a phone, or by cardholder input, such as a response to an email or text message. In any event, contact management system 164 communicates case update data, investigation data relating to the results of the investigation, card status data, and/or cardholder information data to virtual analyst system 160 after each cardholder contact attempt. Virtual analyst system 160 then updates fraud scoring system 162 with the case update data and/or investigation data. Virtual analyst system 160 also updates cardholder management system 166 with the card status data and/or cardholder information data. In the exemplary embodiment, contact management system 164 is Adeptra™ (trademark of Adeptra, Inc., located in Norwalk, Conn.).

Cardholder management system 166 includes a database associated with a payment card network that stores cardholder card and contact information. The information stored in the database is provided by a potential cardholder upon application for a payment card. When contact management system 164 sends a request to virtual analyst system 160 for a cardholder's card and contact information as described above, card manager 604 and contact information manager 606 of virtual analyst system 160 communicate with cardholder management system 166 to obtain the requested information.

In an alternative embodiment, fraud management platform 121 includes issuer interface 168. Issuer interface 168 enables fraud management platform 121 to access a database associated with a payment card issuer that chooses to manage its clients' information separately from the payment card network. The database may contain additional contact information. Contact information manager 606 and contact event manager 608 of virtual analyst system 160 communicate through issuer interface 168 to obtain the information in response to a request from contact management system 164. If any cardholder information is missing or inconsistent with the data in cardholder management system 166, the data in the issuer's database may supplement or override the information stored in cardholder management system 166. If the issuer chooses for its information to control inconsistencies, cardholder management system 166 may be updated to contain the correct or additional cardholder information.

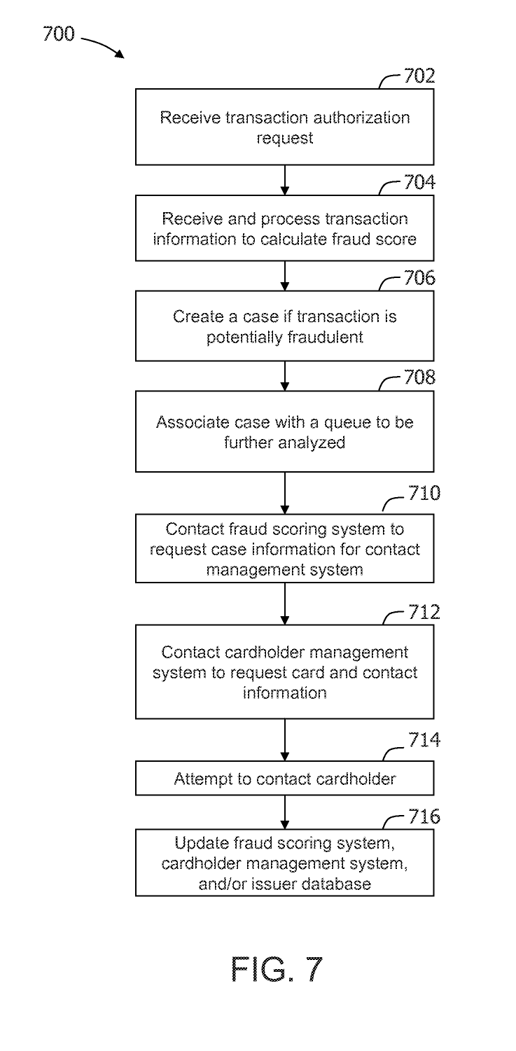

FIG. 7 is a flow diagram 700 illustrating operation of fraud management platform 121 as shown in FIGS. 2, 3, and 6. In operation, fraud management platform 121 receives 702 an authorization request message, including the transaction data, for a payment card transaction from a payment card network. Fraud scoring system 162 (shown in FIGS. 3 and 6) receives and processes 704 the incoming authorization request message to calculate a fraud score for the transaction, representing the likelihood that the transaction is fraudulent. If the fraud score meets a predetermined threshold level, fraud scoring system 162 creates 706 a case for the transaction. Fraud scoring system 162 then associates 708 the case with one or more queues in a database of fraud scoring system 162. Each queue includes cases having similar characteristics, such as time and location of the transaction, type of merchant or goods, and overall fraud score. Cases placed in a queue are analyzed by either a human or fraud management platform 121.

For analyzing cases marked as potentially fraudulent, contact management system 164 (shown in FIGS. 3 and 6) communicates with virtual analyst system 160 (shown in FIGS. 3 and 6) at predetermined time intervals and requests a list of cases to be analyzed. Upon receiving the request, virtual analyst system 160 contacts fraud scoring system 162 to obtain the list of cases. Contact management system 164 then communicates with virtual analyst system 160 to request case information and to request the cardholder's card and contact information for a specific case. In turn, virtual analyst system 160 contacts 710 fraud scoring system 162, and contacts 712 cardholder management system 166 (shown in FIGS. 3 and 6) and, optionally, issuer interface 168 (shown in FIGS. 3 and 6) to obtain cardholder information and cardholder preferences.

Contact management system 164 determines if a contact window is open as specified by the cardholder and if it is, an attempt is made to contact the cardholder. If the contact window is closed, contact management system 164 schedules a time to attempt contact when the window is open. At the scheduled time, contact management system 164 contacts virtual analyst system 160 to get updated case data for the case, which may be open, closed, or being handled by another analyst. Virtual analyst system 160 communicates with fraud scoring system 162 to request the updated case data, and provides it to contact management system 164.

Upon determining the case is open and receiving the cardholder's payment card and contact information, contact management system 164 determines when and how to contact the cardholder to verify the transaction. The cardholder may specify preferred forms of communication to contact the cardholder in the event of potentially fraudulent activity. The forms of communication include a phone call, an email, and/or a text message. Depending on the form of communication chosen by the cardholder, there may be a set timeframe, or contact window, for contact management system 164 to initiate contact with the cardholder. If the contact window is open, contact management system 164 attempts to contact 714 the cardholder. If the window is closed, contact management system 164 schedules a contact attempt during an open contact window time. At the scheduled time, contact management system 164 requests case update data from virtual analyst system 160 to confirm the case has not been closed or handled by another analyst. As part of the case update, virtual analyst system 160 communicates with fraud scoring system 162 to retrieve any case update data, which is then provided to contact management system 164 via virtual analyst system 160.

After each attempt at contacting the cardholder, contact management system 164 updates virtual analyst system 160. In turn, virtual analyst system 160 may perform a number of operations depending on the information received from contact management system 164. Virtual analyst system 160 may update 716 fraud scoring system's 162 database with case update data or investigation data that includes the cardholder's response for updating fraud scoring system's 162 scoring algorithms. Virtual analyst system 160 may also forward the case to another user or group within fraud management platform 121. Moreover, virtual analyst system 160 may update 716 cardholder management system 166 with card status data representing the status of the cardholder's payment card, or may update cardholder information data associated with the cardholder's contact information and contact preferences. If the card issuer operates its own customer information database, virtual analyst system 160 may communicate the updated card status data and/or the cardholder information data via issuer interface 168.

The above-described methods and systems provide for automatic investigation of fraudulent transactions by a payment card issuer processor. The methods and systems described herein facilitate automatically implementing and managing an investigation of a payment card transaction marked as potentially fraudulent, communicating with the cardholder for transaction verification, and updating a fraud scoring system with the result of the investigation to assist in preventing subsequent fraudulent transactions.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for managing an investigation of potentially fraudulent payment card transactions, said computer system comprising:
a memory device for storing data; and
a processor in communication with said memory device, said computer system programmed to:
retrieve a case representing at least one transaction initiated with a payment card and designated as potentially fraudulent;
provide the case to a contact management system;
retrieve cardholder card and contact information for the actual cardholder associated with the payment card used in the at least one transaction; and
provide the cardholder card and contact information to the contact management system, wherein the cardholder card and contact information is configured to prompt the contact management system to automatically initiate an investigation into the case.

2. A computer system in accordance with claim 1, wherein said computer system is further programmed to communicate with a fraud scoring system, including receiving cases from the fraud scoring system, the fraud scoring system configured to analyze transactions initiated with a payment card and designate certain transactions as potentially fraudulent, wherein transactions designated as potentially fraudulent are cases.

3. A computer system in accordance with claim 1, wherein said computer system is further programmed to receive investigation data from the contact management system, the investigation data including one of a confirmation and a denial from the actual cardholder whether the at least one transaction was authorized by the actual cardholder.

4. A computer system in accordance with claim 3, wherein said computer system is further programmed to communicate the investigation data to a fraud scoring system.

5. A computer system in accordance with claim 1, wherein to retrieve cardholder card and contact information, the computer system communicates with a cardholder management system that stores cardholder card and contact information.

6. A computer system in accordance with claim 1, wherein said computer system is further programmed to communicate at least one of card status data and cardholder information data to a cardholder management system, wherein card status data represents a status of the financial transaction card after the investigation, and cardholder information data represents updated cardholder contact information and contact preferences.

7. A computer system in accordance with claim 1, wherein said computer system is further programmed to:
retrieve additional cardholder contact information by communicating with an issuer through an issuer interface; and
provide the additional cardholder contact information to the contact management system.

8. A computer system in accordance with claim 7, wherein said computer system is further programmed to communicate cardholder information data to the issuer through the issuer interface, wherein cardholder information data represents updated cardholder contact information and contact preferences.

9. A computer system in accordance with claim 1, wherein cardholder contact information comprises at least one of the cardholder's name, address, phone number, email address, a timeframe in which to contact the cardholder, events to occur for contact to be made, and at least one preferred form of communication for contacting the cardholder.

10. A computer-implemented method of managing an investigation of potentially fraudulent payment card transactions using a virtual analyst computing device, wherein the virtual analyst computing device includes a memory device and a processor, said method comprising:
using the virtual analyst computing device to retrieve case data representing at least one transaction initiated with a payment card and designated as potentially fraudulent;
transmitting the case data to a contact management computing system;
using the virtual analyst computing device to retrieve cardholder card and contact information for the actual cardholder associated with the payment card used in the at least one transaction; and
providing the cardholder card and contact information to the contact management computing system, wherein the cardholder card and contact information is configured to prompt the contact management computing system to automatically initiate an investigation into the case.

11. A computer-implemented method in accordance with claim 10, further comprising communicating with a fraud scoring computing system, including receiving case data from the fraud scoring computing system, the fraud scoring computing system configured to analyze transactions initiated with a payment card and designate certain transactions as potentially fraudulent, wherein transactions designated as potentially fraudulent are cases.

12. A computer-implemented method in accordance with claim 10, further comprising receiving investigation data from the contact management computing system, the investigation data including one of a confirmation and a denial from the actual cardholder whether the at least one transaction was authorized by the actual cardholder.

13. A computer-implemented method in accordance with claim 12, further comprising communicating the investigation data to a fraud scoring computing system.

14. A computer-implemented method in accordance with claim 10, wherein retrieving cardholder card and contact information comprises communicating with a cardholder management computing system to retrieve cardholder card and contact information.

15. A computer-implemented method in accordance with claim 10, further comprising communicating at least one of card status data and cardholder information data to a cardholder management computing system, wherein card status data represents a status of the financial transaction card after the investigation and cardholder information data represents updated cardholder contact information and contact preferences.

16. A computer-implemented method in accordance with claim 10, further comprising:
retrieving additional cardholder contact information by communicating with an issuer through an issuer interface; and
providing additional cardholder contact information to the contact management computing system.

17. A computer-implemented method in accordance with claim 16, further comprising communicating cardholder information data to the issuer through the issuer interface, wherein cardholder information data represents updated cardholder contact information and contact preferences.

18. One or more non-transitory computer-readable storage media having computer-executable instructions embodied thereon for managing an investigation of a potentially fraudulent payment card transaction by a computing device, wherein the computing device includes a memory device and a processor, wherein when executed by said processor, the computer executable instructions cause said processor to:
retrieve a case representing at least one transaction initiated with a payment card and designated as potentially fraudulent;
provide the case to a contact management system;
retrieve cardholder card and contact information for the actual cardholder associated with the payment card used in the at least one transaction; and
provide the cardholder card and contact information to the contact management system, wherein the cardholder card and contact information is configured to prompt the contact management system to automatically initiate an investigation into the case.

19. The one or more non-transitory computer-readable storage media in accordance with claim 18, wherein said computer-executable instructions further cause the processor to communicate with a fraud scoring system, including receiving cases from the fraud scoring system, the fraud scoring system configured to analyze transactions initiated with a payment card and designate certain transactions as potentially fraudulent, wherein transactions designated as potentially fraudulent are cases.

20. The one or more non-transitory computer-readable storage media in accordance with claim 18, wherein said computer-executable instructions further cause the processor to:
receive investigation data from the contact management system, the investigation data including one of a confirmation and a denial from the actual cardholder whether the at least one transaction was authorized by the actual cardholder; and
communicate the investigation data to a fraud scoring system.

21. The one or more non-transitory computer-readable storage media in accordance with claim 18, wherein to retrieve cardholder card and contact information, said computer-executable instructions cause the processor to communicate with a cardholder management system that stores cardholder card and contact information.

22. The one or more non-transitory computer-readable storage media in accordance with claim 18, wherein said computer-executable instructions further cause the processor to communicate at least one of card status data and cardholder information data to a cardholder management system, wherein card status data represents a status of the financial transaction card after the investigation and cardholder information data represents updated cardholder contact information and contact preferences.

23. The one or more non-transitory computer-readable storage media in accordance with claim 18, wherein said computer-executable instructions further cause the processor to:
retrieve additional cardholder contact information by communicating with an issuer through an issuer interface; and
provide the additional cardholder contact information to the contact management system.

24. A computer system in accordance with claim 1, wherein cardholder contact information includes a preferred form of communication specified by the cardholder, the preferred form of communication enables the contact management system to automatically and directly contact the cardholder using the preferred form of communication.
